(19) United States
(12) Patent Application Publication
(10) Pub. No.: US 2005/0283723 A1
(43) Pub. Date: Dec. 22, 2005

(54) Electronic reference system

(76) Inventor: Rex Fish, Spanish Fork, UT (US)

Correspondence Address: Starkweather & Associates, Suite 200, 9035 South 1300 East, Sandy, UT, 84094, US

(21) Appl. No.: 11/158,543

(22) Filed: Jun. 22, 2005

Related U.S. Application Data
(60) Provisional application No. 60/581,883, filed on Jun. 22, 2004.

(51) Int. Cl. G06F 17/21

(52) U.S. Cl. 715/526; 715/764

(57) ABSTRACT

An electronic reference system with a cross-referencing module, a highlighting module, a notes module, and an arranging module. The cross-referencing module stores at least one reference material and cross-references the at least one reference material. The highlighting module marks particular words or phrases. The notes module stores notes corresponding to particular words or phrases. The arranging module tags the highlighted words or phrases or notes. The event may be a date, time, topic, and so forth. The arranging module may also arrange the notes or highlighted words or phrases according to the tag. The electronic device may also the at least one reference material.

This invention claims priority, under 35 U.S.C. § 119, to the U.S. Provisional Patent Application No. 60/581, 883 to Rex Fish filed on 22 Jun. 2004, which is incorporated herein by reference.

### BACKGROUND OF THE INVENTION

1. Field of the Invention

The present invention relates to electronic reference systems and methods, specifically electronic reference systems and methods that allow a user to highlight particular phrases or words, cross-reference at least one reference material stored on the device, store notes corresponding to particular phrases or words, and arrange highlighted phrases or words and stored notes.

2. Description of the Related Art

There exists computer software that allows for searching for words or phrases in documents. The user may type in a term to be searched, command the software to search for the term within the document, and the software will return a list of the places where the word or phrase is found. The software may also highlight each occurrence of the word or phrase within the document.

In some instances, a user is interested in a certain word or phrase in more than one document or source. For example, a user may be researching a scriptural word or phrase, and is interested in the occurrence of that word or phrase in a number of sources such as the scriptures, old and new commentary to the scriptures, books, manuals and other references about the scriptures, and so forth.

Paper books, references, commentary, and so forth are convenient in that the user may make marks and notations on the pages along with the text. The user may then go back to study the notes that he kept. However, paper is not electronically searchable for words and phrases. Further, though the paper version may have an index, not all of the words or phrases in the paper version are typically referenced in the index. Even if all of the words of the text are referenced in the index, the words of the notes that the user keeps on the pages of the text are not referenced in the index. Likewise, any notes made by the user may not be arranged in any manner that the user desires.

What is needed is an electronic reference system that allows for the cross referencing between more than one source and make and arrange notes corresponding to a word or phrase in a source.

### SUMMARY OF THE INVENTION

The present invention has been developed in response to the present state of the art, and in particular, in response to the problems and needs in the art that have not yet been fully solved by currently available electronic reference systems. Accordingly, the present invention has been developed to provide an electronic reference system with a cross-referencing module, a highlighting module, a notes module and an arranging module. The system stores at least one reference material, and the cross-referencing module cross-references the at least one reference material. The highlighting module may be used to mark a particular word. The notes module stores notes corresponding to the particular word. The arranging module tags a highlight, note or both. The device may display the reference material. The marking may be with a single color, multiple colors, by underline, circle, block, strikethrough, bold, italics, and so forth.

The display may be limited to words with similar marking. The tagging may be with an event tag such as a date, time, topic, or combinations. Tabs may be displayed that represent reference material. The device may be configured to show only the tabs that represent reference material that corresponds to the highlighted word. More than one reference material may be stored and cross-referenced. The reference material may be text, maps, and so forth.

The arranging module may group similar tags. The arranging module may group events. The arranging module may group tags based on the grouping of events. This invention further includes a method of electronic referencing of material comprising the steps of storing at least one reference material, cross-referencing the at least one reference material, marking particular words, storage of notes corresponding to the particular word, and tagging a highlight and/or a note. The method may include displaying of the reference material. The method may include marking with color, underline, circle, block, strikethrough, bold, italics, and mixtures thereof. The tagging may be with an event tag. The arranging may be arranging by event. The arranging may include arranging by groups of notes, highlights, and combinations based on the grouping of events.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a front perspective view of an electronic reference system according to one embodiment of the present invention;

FIG. 2 illustrates a front perspective view of module selection within an electronic reference system according to one embodiment of the present invention;

FIG. 3 illustrates a front perspective view of highlighting a word for cross-reference within an electronic reference system according to one embodiment of the present invention;

FIG. 4 illustrates a front perspective view of a Cross-Referencing module for scripture cross-reference within an electronic referencing system according to one embodiment of the present invention;

FIG. 5 illustrates a front perspective view of New Testament cross-references displayed using a Cross-Referencing module within an electronic referencing system according to one embodiment of the present invention;

FIG. 6 illustrates a front perspective view of a Cross-Referencing module within an electronic referencing system for manual cross-reference according to one embodiment of the present invention;

FIG. 7 illustrates a front perspective view of manual cross-references displayed using a Cross-Referencing module within an electronic referencing system according to one embodiment of the present invention;

FIG. 8 illustrates a front perspective view of a Notes module within an electronic referencing system for editing notes according to one embodiment of the present invention; and

FIG. 9 illustrates a front perspective view of an Arranging module within an electronic referencing system for arranging notes according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, (comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The present invention relates to an electronic reference system that may be used for facilitating the study of a particular topic. In one embodiment, the electronic reference system comprises a cross-referencing module configured to cross-reference at least one reference material stored on the electronic reference system, a highlighting module configured to allow a user to highlight a particular phrase or word, a notes module configured to store a note corresponding to the phrase or word, and an arranging module configured to provide a date indicating when the highlight and note was made and to arrange the highlight and note according to date, topic, event, and so forth.

In one embodiment, the electronic reference system is configured to cross-reference other writings and images from other authors, highlight text, allow the user to insert notes including personal thoughts and knowledge related to the particular topic, arrange all changes, highlights, and personal thoughts and knowledge by date, event, and topic, show all passages related to the topic based on pre-colored text, select word(s) and sections for pronunciation, definition, and audio, and purchase similar writings and options from other authors.

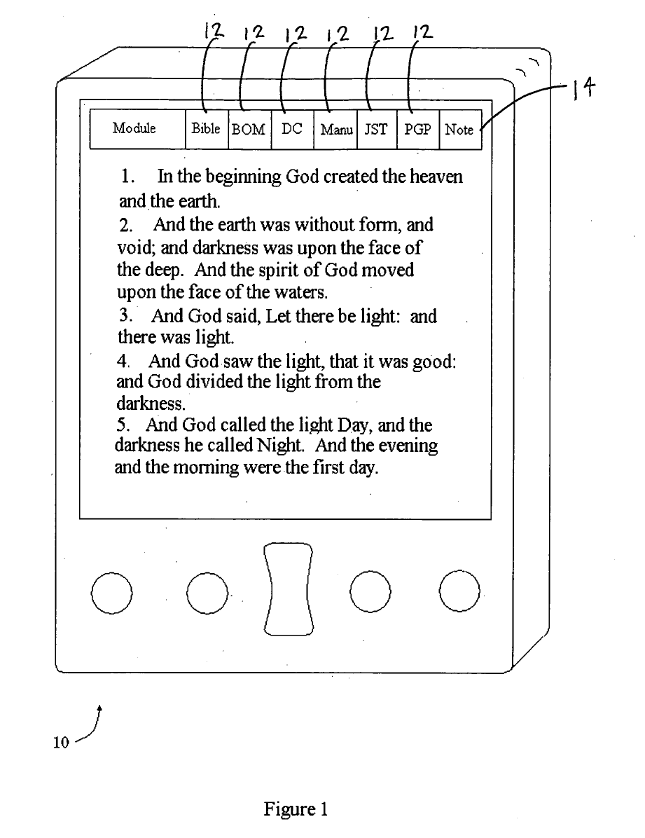

FIG. 1 illustrates an electronic reference system 10 configured to store information according to one embodiment of the present invention. The electronic reference system 10 may be configured to store and display available writings 12. Non-limiting examples of such writings may include: academic journals, abstracts, professional journals, textbooks, reference books, guide books, gospel information, The Bible, The Book of Mormon, The Pearl of Great Price, The Doctrine and Covenants, The Joseph Smith Translation, Priesthood and Relief Society manuals, gospel magazines, hymns, newspapers, any other type of gospel related electronic writings or images, and so forth. The available writings 12 may be displayed as tabs.

All documents may be available in any translation and any version. For instance, The Bible may be translated into Spanish, German, French, and versions other than The King James version may be available, such as the version used by Jehovah Witnesses. Additionally, the electronic reference system 10 may be configured to display the writings in more than one language at a time. As an example, if the user is learning Spanish, the electronic reference system 10 displays the writing in both English and Spanish, the Spanish words being displayed either above, next to, or below the English version.

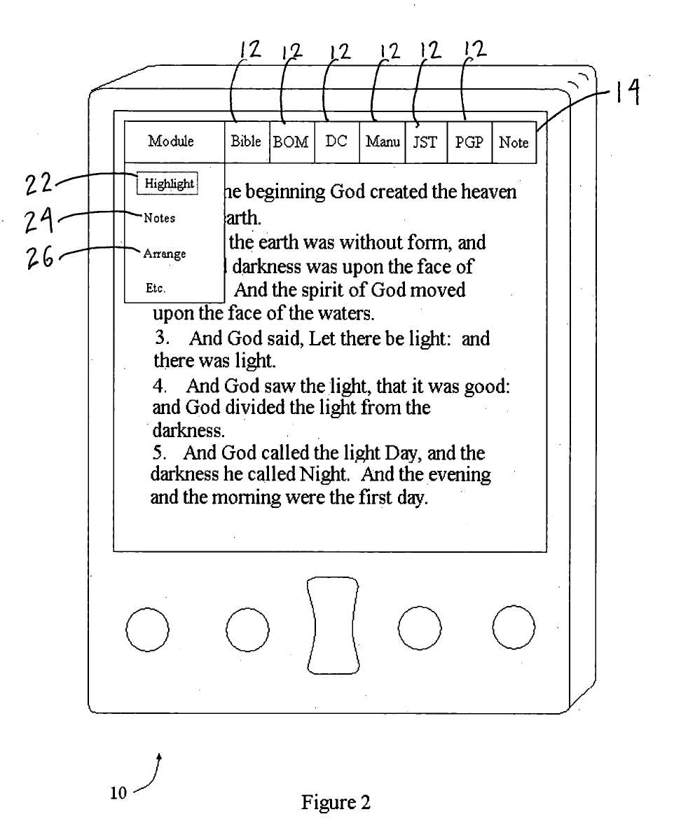

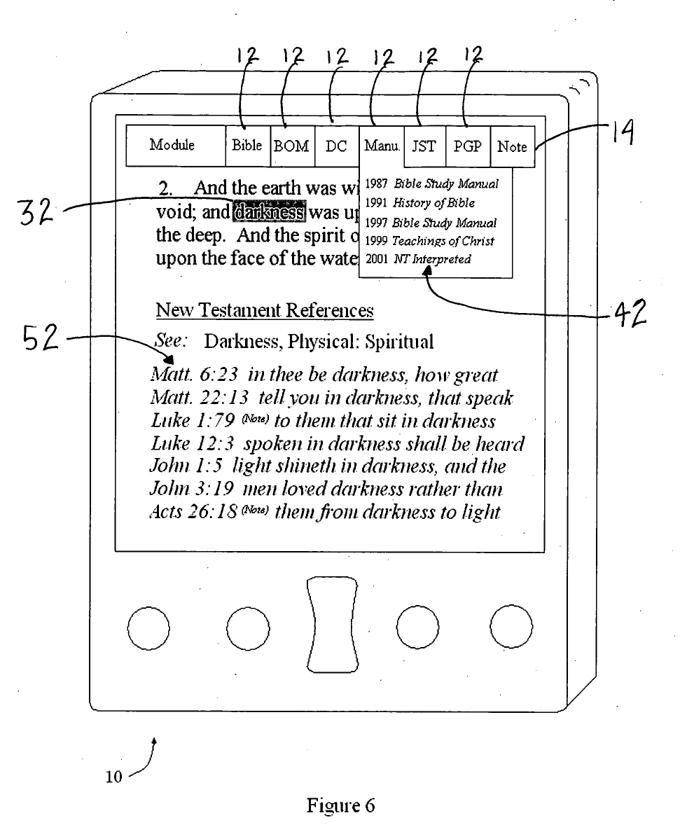

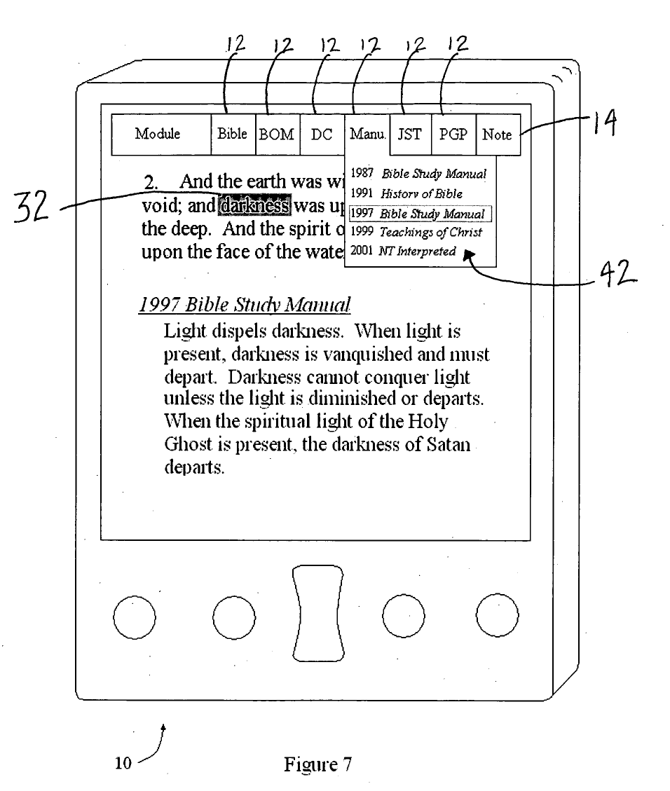

FIGS. 2-7 illustrate various embodiments of the cross-referencing module on the electronic reference system 10. In one embodiment, the cross-referencing module is configured to cross-reference all available writings 12 stored on the electronic reference system 10. Accordingly, passages, key words, topics, and phrases of The Bible may be cross-referenced with similar passages, key words, topics, and phrases from the available writing 12 as described above. The cross-referencing module may allow the user to improve research and knowledge by comparing the various explanations from each type of gospel reference tool.

The user may initiate the cross-referencing module after using the highlighting module 22 to highlight a particular phrase or passage, resulting in a highlighted word or phrase 32. It is noted that the highlighting module 22 may be configured to allow a user to highlight, underline, mark, block, strikethrough, bold, or italicize particular passages, words, phrases, etc. of the document. The highlighting module 22 may provide a multiplicity of colors to choose for highlighting the words or phrases. Additionally, the highlighting module 22 may provide options for defining a highlighting method such as underlining, circling, blocking, etc. The electronic reference system 10 may be configured to allow the user to highlight words or phrases and define a highlighting method and create a legend specifying which topics relate to which colors and for identifying highlighted words or phrases 32 according to the content within the passage. For instance, the legend may indicate that all red highlighting represents the words of any member of the Godhead; blue represents a story line, chronology, action, movement, what is happening; purple represents genealogy; orange represents spiritual gifts; green represents teachings of prophets; yellow represents parables, allegories, and similes; pink represents words of praise to God; and black represents words and deeds of Satan. Other colors may be used, and combinations of colors may be used for passages that represent more than one topic.

The passages may be installed, programmed, or otherwise loaded into the electronic referencing system 10 pre-highlighted according to predetermined topics and colors with an option for the user to add topics and change highlight colors. The user may want to change highlight colors if the user feels that the passage refers better to a different topic. With the passages highlighted, the user may specify a particular topic to read about. The electronic referencing system 10 may gather and display those passages that relate to that particular topic. In one embodiment, the user simply chooses a topic from the legend and only those particular highlighted words or phrases 32 as referring to the chosen topic are presented to the user, thus eliminating from view all other passages that do not relate to the chosen topic.

In the illustrated embodiment(s), the electronic reference system 10 may be configured to display a plurality of available writings 12 that may be searched for cross-references. The cross-referencing module may search all documents and images stored on the electronic reference system 10 and provide a list of passages 52 that refer to the highlighted word or phrase 32. The list of passages 52 may be provided as links to visit the passage or the list of passages 52 may be in the form of the passages themselves.

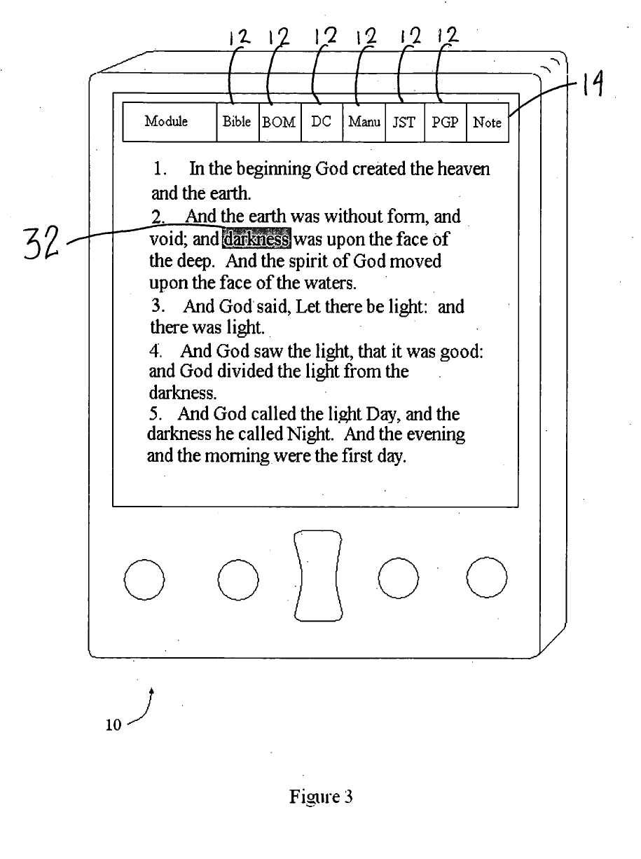

The electronic reference system 10 may be configured to automatically update the available cross-reference tabs depending on the verse that the user is reading. For instance, if the user is reading chapter 1, verse 2 of Genesis (as illustrated in FIG. 3), and highlights a particular word or phrase 32, the cross-referencing module automatically scans the available writings 12 stored on the electronic reference system 10 for the available writings 12 that reference the particular word or phrase. After scanning all available writings 12, the cross-referencing module may be updated to display only those writings that refer to the highlighted word or phrase 32. If an available writing 12 stored on the electronic reference system 10 does not refer to the particular passage, the writing may be removed from the cross-referencing module.

The electronic reference system 10 may be configured to allow the user to view maps that reference a particular passage, word, or event. Specifically, if the user highlights a particular passage relating to the tomb where Jesus was laid, the user may view a map indicating the location where it is believed that Jesus' tomb exists. The ancient maps may be compared with current maps. The maps stored on the electronic reference system 10 may be used for field research such that a person may view the maps while actually at that specific location. The maps may include grid lines to allow the user to zoom in and out of specific areas on the map. The user may view distances from one location on the map to another location, or insert a location and determine distances.

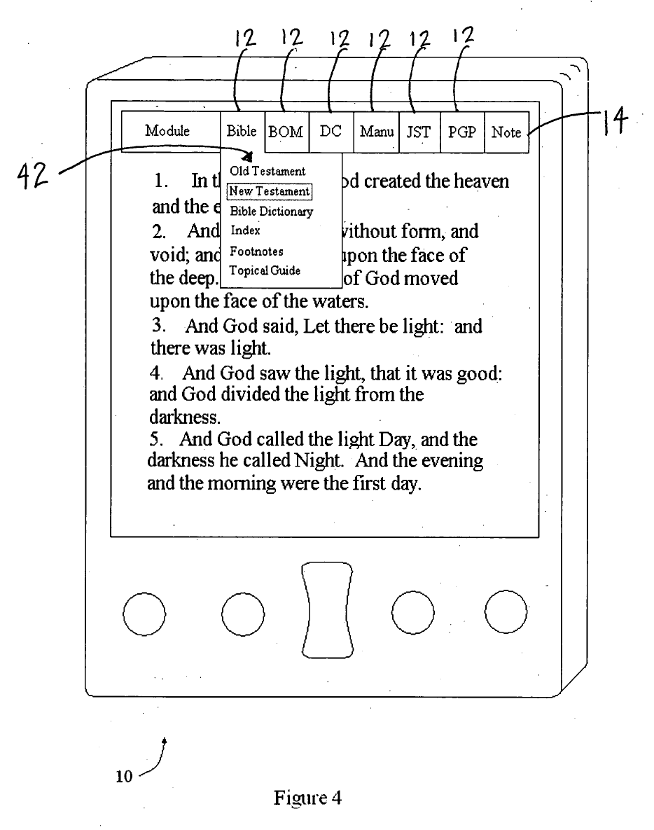

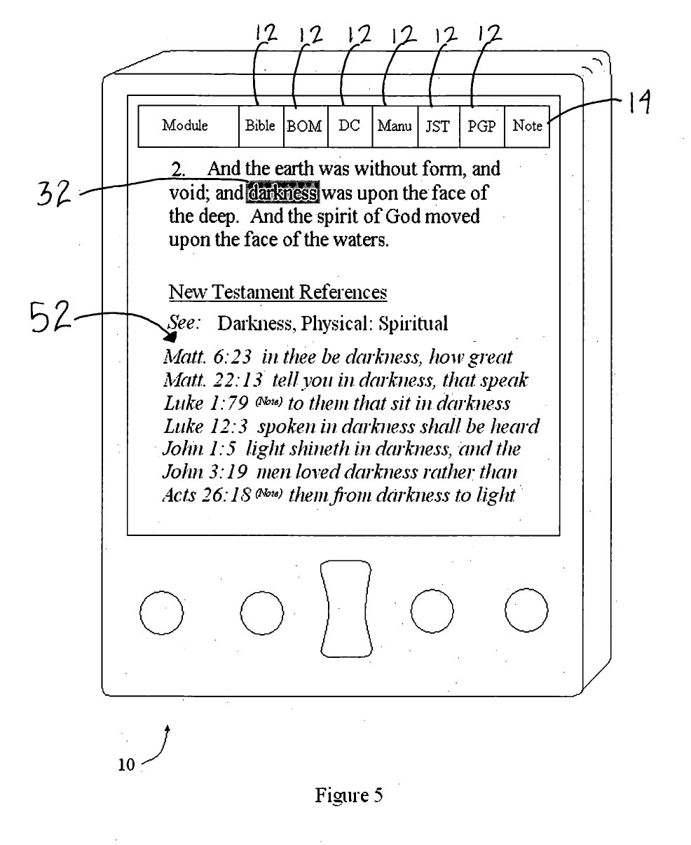

After the cross-reference writings are scanned and displayed, the user may choose a particular writing 42 to view the cross-reference (See FIG. 4). In the illustrated embodiment, the user has chosen to view all references to the word “darkness” found in the New Testament of the Bible. The user may view each passage one after another or link to the individual passages one at a time (See FIGS. 5-7).

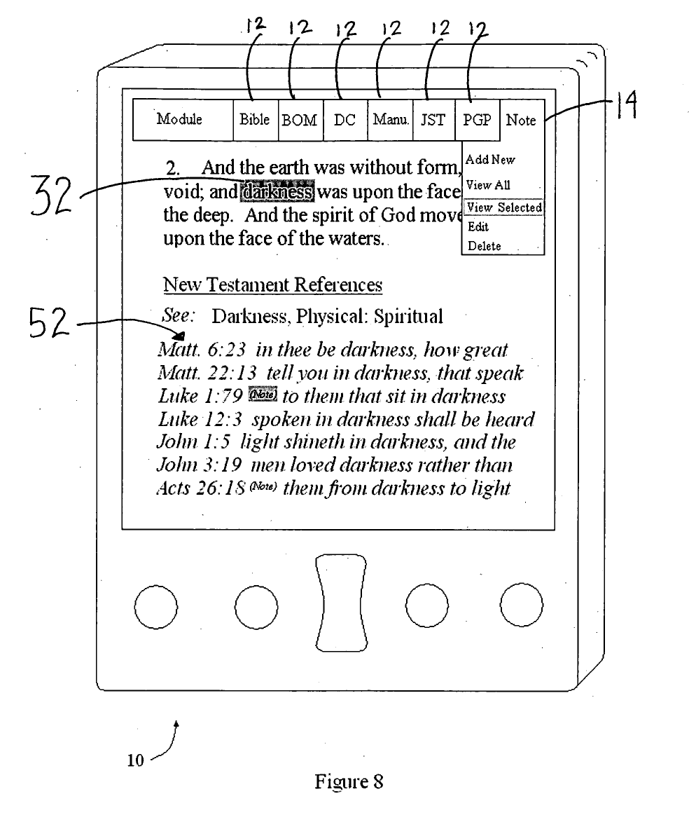

The notes module 24 allows the user to add notes of personal thoughts and knowledge related to the highlighted word or passage 32 and view selected notes (See FIG. 8). For example, when the user is reading about The Last Supper, the user highlights a passage relating to the prayer offered and touches a “notes” tab 14. A blank screen appears and the user is allowed to comment on his/her feelings relating to the passage.

An arranging module 26 may arrange a collection of notes, such as user entries and/or marked or highlighted words. The arranging module 26 may tag a user entry with an event such as descriptions, date, time, topic, event, and so forth. The arranging module may store the date of the highlight and note, which allows the user to see when the note was made. Additionally, the electronic reference system 10 may be configured to allow the user to configure the arranging module 26 to mark notes, comments, and highlights according to events. For example, the user may indicate that all notes, comments, and highlights from nine o'clock in the morning until noon, every Sunday, are made during church meetings, that all notes, comments, and highlights from six o'clock in the morning until seven in the morning are made during seminary, or that all notes, comments, and highlights from June 2004 through June 2006 are made while serving a mission. Combinations of such arranging methods may be used.

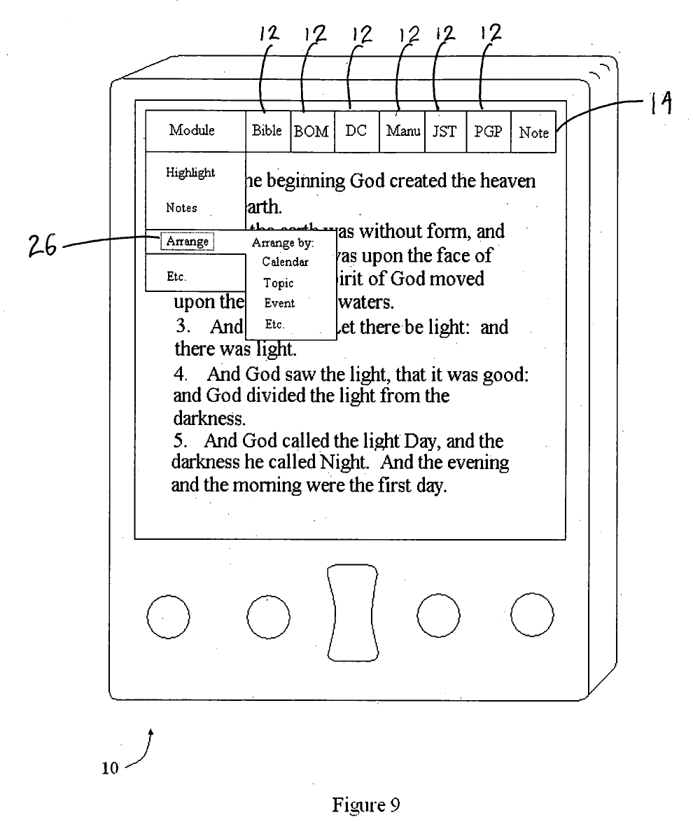

The arranging module 26 may be searchable by date, time, topic, event, and so forth to allow the user to search notes and passages that were made and highlighted during those time periods (See FIG. 9).

After the passage or word has been highlighted or chosen, the user may press a button or tab to have the electronic device read the passage. An internal speaker may be used to transmit the audio or the electronic device may comprise a headphone jack or speaker jack. As discussed above, the electronic reference system 10 may be configured to display the writings in more than one language. The electronic reference system 10 may read the passages in any of the languages. As the writings are read to the user, the words may highlight as they are read to allow the user to follow along. Individual words may be chosen and a language may be chosen to have the word read in that particular language.

The electronic reference system 10 may further comprise a searching module. The searching module may allow the user to speak or write into the electronic reference system 10 a particular passage, phrase, or word. The searching module may then search the available writing 12 and may display the results of the request to the user.

The electronic reference system 10 may be connected to an internet connection to download other available writings 12 such as, for example, books, images, passages, updates and so forth. A remote processing unit, server, or computer may be used to communicate with the electronic reference system 10 to obtain information about the types of topics that the user has been studying. The remote processing unit may gather and transmit to the electronic reference system 10 a list of books, images, passages, and updates relating to the topics that the user has been studying and, which may be of interest to the user. An update module on the electronic reference system 10 stores the lists and if the user wants to purchase one of the recommended books, images, passages, etc., the user may simply choose which ones to download.

As an example, if the user has been studying about forgiveness, the remote processing unit receives information from the electronic reference system 10 that the user has been reading passages related to forgiveness. The remote processing unit gathers recent talks, passages, books, etc. relating to the topic of forgiveness and provides a list to the electronic reference system 10.

It is understood that the above-described arrangements are only illustrative of the application of the principles of the presently illustrated invention. The present invention may, however, be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the specification discusses the use of the electronic reference system 10 for gospel reference, it is envisioned that the electronic reference system 10 may be used for any type of information. For example, it is envisioned that doctors may use the electronic reference system 10 for referring to a plurality of books, studies, journals, speeches, images, etc. The electronic reference system 10 may be used for school textbooks, cookbooks, telephone books, dictionaries, thesauruses, and so forth.

The electronic reference system 10 may be configured to store travel logs for truckers to store all trucking information, such as when stops were made to check load, refuel, sleep, make repairs, perform maintenance, and so forth. The information may be transmitted or shown to check point officials, rather than showing a logbook.

It is also envisioned that the software involved in performing these functions be compatible with all types of electronic reference systems 10 such that the software may be downloaded or transmitted over an internet connection.

The electronic reference system 10 may be configured to store blueprint information. Specifically, the electronic reference system 10 may store architectural plans, land development plans, electrical plans, plumbing, heating, ventilation and air conditioning, utility lines, etc. The user may go from job site to job site with a small compact version of the plans rather than carrying thick cumbersome paper plans. The plans may be stored on disks or other memory devices configured to connect to the electronic device.

Though the drawings illustrate the electronic reference system displayed on a particular physical device, it is envisioned that the electronic display system may be used with any physical device known to one skilled in the art. For example, the electronic reference system may be used with a desktop computer, a laptop computer, a personal data assistant, a network, and so forth.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. An electronic reference system comprising:
storage of at least one reference material;
a cross-referencing module to cross-reference the at least one reference material;
a highlighting module comprising marking of a particular word;
a notes module comprising storage of a note corresponding to the particular word; and
an arranging module comprising tagging one of the entries consisting of a highlight and a note.

2. The electronic reference system of claim 1, further comprising a display module configured to display of the reference material.

3. The electronic reference system of claim 1, wherein the marking of a particular word comprises marking with a single color.

4. The electronic reference system of claim 1, wherein the marking of a particular word comprises marking with one selected from the list consisting of color, underline, circle, block, strikethrough, bold, italics, and mixtures thereof.

5. The electronic device of claim 2, wherein the arranging module comprises grouping of similarly tagged notes and highlights, and wherein the display module comprises display groups from the arranging module.

6. The electronic reference system of claim 1, wherein the tagging comprises tagging with an event.

7. The electronic reference system of claim 6, wherein the event comprises one selected from the list consisting of: date, time, topic, and combinations thereof.

8. The electronic reference system of claim 2, wherein the cross-referencing module comprises:
storage of at least two reference materials; and
cross-referencing the at least two reference materials.

9. The electronic reference system of claim 8, wherein the display comprises:
display of at least one reference material; and
display of at least one tab representing at least one reference material.

10. The electronic reference system of claim 9, wherein the display of the at least one tab comprises display only of tabs representing other reference material with words corresponding to the highlighted word.

11. The electronic reference system of claim 1, wherein the at least one reference material comprises a map.

12. The electronic storage device of claim 1, wherein the arranging module further comprises grouping of similarly tagged notes, highlights, and combinations thereof.

13. The electronic storage device of claim 6, wherein the arranging module further comprises grouping of events.

14. The electronic storage device of claim 13, wherein the arranging module further comprises grouping of notes, highlights and combinations thereof based on the grouping of events.

15. A method for electronic referencing comprising the steps of:
storing at least one reference material;
cross-referencing the at least one reference material;
marking particular words;
storage of notes corresponding to the particular word; and
tagging one of the entries consisting of: a highlight and a note.

16. The method for electronic referencing of claim 15, further comprising the step of displaying the reference material.

17. The method for electronic referencing of claim 15, wherein the marking particular words comprises marking with one selected from the list consisting of color, underline, circle, block, strikethrough, bold, italics, and mixtures thereof.

18. The method of electronic referencing of claim 15, wherein the tagging comprises tagging with an event

19. The method of electronic referencing of claim 18, wherein the step of arranging further comprises arranging of events.

20. The method of electronic referencing of claim 19, wherein the step of arranging further comprises grouping of notes, highlights and combinations thereof based on the grouping of events.
